(19) United States
(12) Patent Application Publication
(10) Pub. No.: US 2006/0069463 A1
(43) Pub. Date: Mar. 30, 2006

(54) Trespass detecting system and method

(75) Inventor: Sang-Yun Kim, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/213,734

(22) Filed: Aug. 30, 2005

(30) Foreign Application Priority Data
Sep. 24, 2004 (KR) 10-2004-77390

(51) Int. Cl. G06F 19/00

(52) U.S. Cl. 700/245; 318/568.12

(57) ABSTRACT

A trespass detecting system includes a motion detector installed at a specific area, detecting motion and generating a motion detect signal, and transmitting the generated motion detect signal A mobile robot photographs the specific area based on the motion detect signal and transmits the photographing image signal. A network connector transmits the motion detect signal and the image signal to a user terminal through an Internet network. A specific area of a house is monitored on a real time basis, and when a trespasser is detected in the specific area, the specific area is quickly photographed and the photographed image is transmitted to the user. Thus, an enhanced security function can be performed.

### CROSS REFERENCE TO RELATED APPLICATION

The present disclosure relates to subject matter contained in Korean Application No. 10-2004-77390 filed on Sep. 24, 2004, the disclosure of which is herein expressly incorporated by reference in its entirety.

### BACKGROUND OF THE INVENTION

1. Field of the Invention

The present invention relates to trespass detecting [system and its method], and more particularly, to trespass detecting [system] using a mobile robot, such as a robot cleaner [and its method].

2. Description of the Conventional Art

In general, a mobile robot is a device for automatically cleaning an area by vacuuming foreign substances, such as dust, from the floor while moving in a room (e.g., a living room or an inner room, etc.) of a house by itself without user manipulation.

In cleaning, the robot cleaner discriminates a distance from itself to an obstacle such as furniture, office supplies or a wall in a cleaning area through a distance sensor and selectively controls a motor for rotating its left wheel and a motor for rotating its right wheel according to the discriminated distance to thereby change its direction and automatically clean the cleaning area. Herein, the robot cleaner performs the cleaning operation while traveling in the cleaning area through map information stored in an internal storage unit.

For example, the robot cleaner includes a gyro sensor for sensing a direction of the robot cleaner, an encoder for determining a traveling distance by sensing the number of rotations of the wheel of the robot cleaner; an ultrasonic sensor for sensing a distance between the robot cleaner and a target; an infrared ray sensor for sensing an obstacle; and numerous other sensors.

However, the conventional robot cleaner has shortcomings in that because numerous high-priced sensors are installed to perform cleaning by precisely traveling along a pre-set cleaning path, its internal structure is complicated and fabrication cost increases.

In an effort to solve such a problem, a robot cleaner has been developed to perform cleaning by traveling along an arbitrary cleaning path in a random manner.

A traveling device of the robot cleaner in accordance with a conventional art will now be described.

FIG. 1 is a block diagram showing the construction of the traveling device of a robot cleaner in accordance with a conventional art.

As shown in FIG. 1, the traveling device of a conventional robot cleaner includes: an obstacle detecting unit 1 for detecting an obstacle based on an impact amount generated when a robot cleaner going straight ahead in a specific area collides with the obstacle and generating an obstacle detect signal; a controller for stopping traveling of the robot cleaner based on the obstacle detect signal generated by the obstacle detecting unit 1, generating a random angle randomly, and generating a control signal for rotating the robot cleaner according to the random angle; a left motor driving unit 3 for rotating a left motor (ML) 5 of the robot cleaner at a certain speed according to the control signal of the controller 2; and a right motor driving unit 4 for rotating a right motor (MR) 6 of the robot cleaner at a certain speed according to the control signal of the controller 2.

FIG. 2 is a flow chart of a method for moving a robot cleaner in accordance with the conventional art.

First, when a user inputs a cleaning command signal (step S1), the controller 2 generates a control signal to make the rotation speed of the left motor 5 and the right motor 6 equal in order to make the robot cleaner go straight ahead, and simultaneously outputs the control signal to the left motor driving unit 3 and the right motor driving unit 4 (step S2).

The left motor driving unit 3 rotates the left motor 5 according to the control signal of the controller 2. At this time, the right motor driving unit 4 rotates the right motor 6 according to the control signal of the controller 2. Namely, as the left and right motors 5 and 6 are simultaneously rotated, the robot cleaner moves straight ahead.

The obstacle detecting unit detects an obstacle based on an amount of impact generated when the robot cleaner collides with the obstacle, generates an obstacle detect signal, and applies the obstacle detect signal to the controller 2 (step S3). If the obstacle detect signal is not generated, the robot cleaner continuously performs its cleaning operation.

The controller 2 stops traveling of the robot cleaner according to the obstacle detect signal, generates a random angle randomly (step S4), generates a control signal for rotating the robot cleaner according to the random angle, and then outputs the generated control signal to the left and right motor driving units 3 and 4.

The left motor driving unit 3 rotates the left motor 5 according to the control signal of the controller 2, and the right motor driving unit 4 rotates the right motor 6 according to the control signal of the controller. In other words, by controlling the rotation speed of the left motor 5 and the rotation speed of the right motor 6 differently, the direction of the robot cleaner can be changed to a random angle (step S5).

Thereafter, when the robot cleaner is rotated as much as the random angle, the controller allows the robot cleaner to go straight ahead (step S6). When the cleaning operation of the robot cleaner is completed, the controller terminates the cleaning operation (step S7). If the cleaning operation of the robot cleaner is not completed, the controller allows the robot cleaner to repeatedly perform the cleaning operation.

Meanwhile, recently, a robot cleaner having a multimedia function as well as a cleaning function has been developed. Namely, the robot cleaner can download various contents by connecting to an Internet network or to a wireless communication network and reproduces the downloaded contents. The robot cleaner also has a function of photographing a cleaning area with a camera and transmitting the photographed image to an external user terminal.

In addition, a robot cleaner having an improved security function has been developed, which patrols a dangerous zone periodically at pre-set time intervals and reports about an internal situation (e.g., the situation in the living room or in the inner room, etc.). However, this method has a problem that the robot cleaner cannot monitor a specific area on a real time basis. For example, on the assumption that the robot cleaner takes 5 minutes for patrolling both the living room and the inner room and patrols a door of the living room whenever 5 minutes elapses, if a trespasser enters the living room of a house through the door while the robot cleaner is patrolling the inner room, the robot cleaner cannot photograph the invader in the living room.

U.S. Pat. Nos. 5,440,216 and 5,646,494 also disclose a robot cleaner.

### SUMMARY OF THE INVENTION

Therefore, an object of the present invention is to provide a trespass detecting system and method capable of an enhanced security function by monitoring a specific indoor area on a real time basis, quickly photographing the specific area if a trespasser is detected in the specific area, and transmitting the photographed image to a user.

To achieve these and other advantages and in accordance with the purpose of the present invention, as embodied and broadly described herein, there is provided a trespass detecting system including: a motion detector installed at a specific area, detecting certain motion and, in response, generating a motion detect signal, and transmitting the generated motion detect signal. The system further includes a mobile robot for photographing the specific area based on the motion detect signal and transmitting the photographed image signal; and a network connector for transmitting the motion detect signal and the image signal to a user terminal through a network, such as the Internet.

To achieve the above object, there is also provided a trespass detecting system including: a motion detector installed in a specific area regarded as a dangerous zone, detecting certain motion and, in response, generating a motion detect signal, and transmitting the generated motion detect signal; a mobile robot for photographing a cleaning area through a camera, photographing the specific area based on the motion detect signal, and transmitting an image signal of the photographed specific area. The system further includes a network connector for transmitting the motion detect signal and the image signal to a mobile terminal of a user through a wireless network, such as the Internet.

To achieve the above object, there is also provided a trespass detecting system including: a motion detector having infrared ray transceivers for detecting whether certain motion of a trespasser exists in a specific area, a controller for generating a motion detect signal when certain motion of the trespasser is detected by the infrared ray transceivers, and a first wireless communicating unit for converting the motion detect signal output from the controller into a wireless communication signal and transmitting the converted wireless communication signal. The system also includes a robot cleaner having a second wireless communicating unit for receiving the motion detect signal, a microcomputer for generating a control signal for photographing the specific area, and a camera for photographing the specific area based on the control signal and outputting an image signal of the photographed specific area. The system further includes a network connecting unit having a third wireless communicating unit for receiving the motion detect signal and the image signal from the second wireless communicating unit, a CPU for converting the motion detect signal and the image signal received through the third wireless communicating unit into a transfer protocol for network communication and transmitting the signals converted into the transfer protocol to a mobile terminal of a user through a wireless network, such as the Internet. The system also includes a memory for storing the image signal received through the third wireless communicating unit. The microcomputer outputs the image signal output from the camera to the second wireless communicating unit and the second wireless communicating unit transmits the image signal output from the microcomputer to the network connecting unit through wireless communication.

To achieve the above object, there is also provided a trespass detecting method using a robot cleaner including: switching a mode of a robot cleaner to a trespass detection mode, detecting motion of a trespasser who is trespassing in a specific area through an infrared ray transmitter/receiver and generating a motion detect signal. The method further includes photographing the specific area through a camera of the robot camera based on the motion detect signal and outputting an image signal of the photographed specific area; and transmitting the image signal to a mobile terminal of a user through a wireless network, such as the Internet.

In accordance with another aspect of the present invention, a trespass detecting method for use with a mobile robot includes detecting motion of a trespasser in an area, and generating a motion detect signal in response to the detecting. The method also includes transmitting the motion detect signal to the mobile robot, and photographing the area with a camera of the mobile robot, based upon the motion detect signal. The method further includes outputting an image signal based upon the photograph, and transmitting the image signal and the motion detect signal, via a wireless network (e.g., CDMA or GSM), to a terminal of a user. The method may also include receiving instructions to switch a mode of the mobile robot to a trespass detection mode. In alternate embodiments, the wireless network is a UMTS network, TDMA network, GPRS network, EDGE network, W-CDMA network, or WiMax 802.16 network, instead of a GSM or CDMA network.

In yet another aspect, a trespass detecting mobile robot system, including a mobile robot, includes a receiver that receives a motion detect signal generated in response to detection of a trespasser in a monitored area. The system also includes a camera that photographs the monitored area in response to receiving the motion detect signal. The system also includes a signal generator that generates an image signal based upon the photographing. In addition, the system includes a transmitter that transmits the image signal to a user terminal via a network, such as a CDMA network or a GSM network.

The transmitter can be part of a network connector, which receives the image signal from a mobile robot transmitter. The mobile robot transmitter can also transmit the motion detect signal to the network connector, and the transmitter can also transmit the motion detect signal to the user terminal via the CDMA or GSM network. In one embodiment, the mobile robot is a robot cleaner. Instead of a CDMA or GSM network, the network can be a UMTS network, TDMA network, GPRS network, EDGE network, W-CDMA network, or WiMax 802.16 network or any other network.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing a construction of a traveling apparatus of a robot cleaner in accordance with a conventional art;

FIG. 2 is a flow chart of a traveling method of the robot cleaner in accordance with the conventional art;

FIG. 3 is a block diagram showing a construction of a trespass detecting system using a robot cleaner in accordance with a first embodiment of the present invention;

FIG. 4 is a block diagram showing a construction of a trespass detecting system using a robot cleaner in accordance with a second embodiment of the present invention;

FIG. 5 is a block diagram showing a construction of a trespass detecting system using a robot cleaner in accordance with a third embodiment of the present invention;

FIG. 6 is a flow chart of a trespass detecting method using the robot cleaner in accordance with an aspect of the present invention; and

FIG. 7 is a block diagram showing a construction of a trespass detecting system using a robot cleaner in accordance with another embodiment of the present invention.

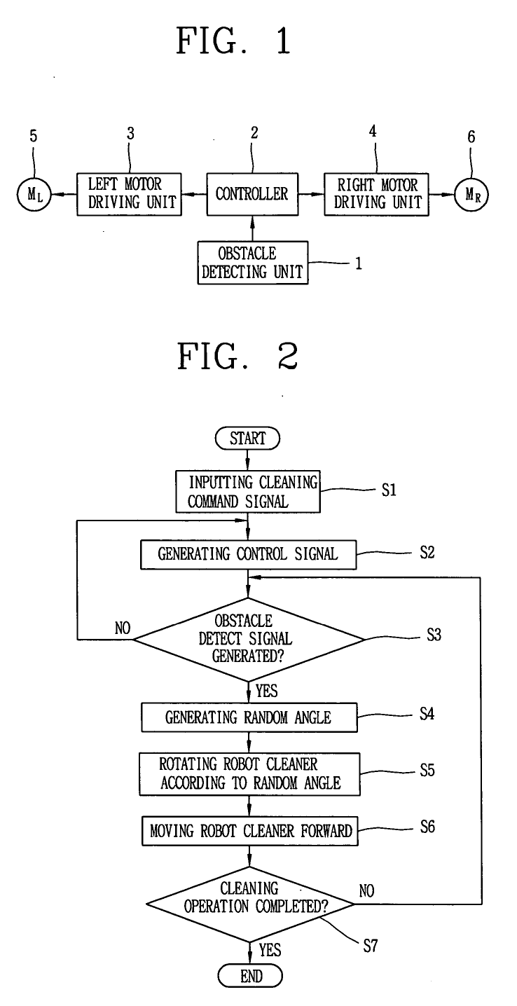

### DETAILED DESCRIPTION OF THE PREFERRED EMBODIMENTS

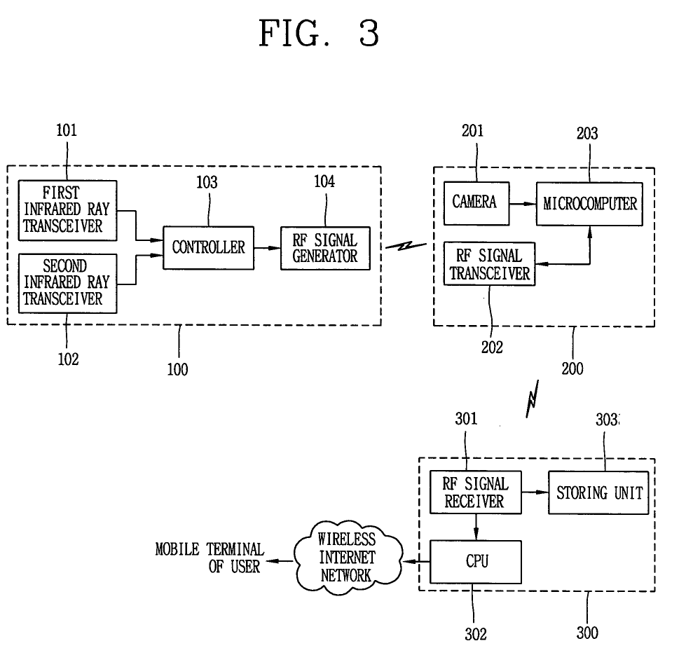

A trespass detecting system and method capable of an enhanced security function by monitoring an specific indoor area on a real time basis, quickly photographing the specific area if a trespasser is detected in the specific area, and transmitting the photographed image to a user, in accordance with preferred embodiments of the present invention will now be described with reference to FIGS. 3 to 6. Although a “trespasser” is mentioned, a trespasser in the legal sense of the word is not intended. Rather, a “trespasser” can be any person or object that is detected in the specific area (which can also be an outdoor area). For example, a child, elderly person, or animal leaving the premises (via the specific area) could be detected. Similarly, any person or object entering the premises via the specific area could be detected.

FIG. 3 is a block diagram showing the construction of a trespass detecting system using a robot cleaner in accordance with a first embodiment of the present invention.

As shown in FIG. 3, a trespass detecting system using a robot cleaner such as a mobile robot includes: a motion detector 100 fixedly installed at a trespass area (e.g., a front door of a house) which is regarded as a dangerous zone that a trespasser may enter, detecting certain motion (e.g., motion of a trespasser) in the trespass area and transmitting a motion detect signal; a robot cleaner 200 for performing a cleaning function, photographing the trespass area based on the motion detect signal transmitted from the motion detector 100, and transmitting an image signal of the photographed trespass area; and a network connector 300 for transmitting the motion detect signal transmitted from the motion detector 100 and the image signal to a mobile terminal of a user through a wireless Internet network.

The cleaning function of the robot cleaner 200 is the same as the conventional art, a detailed description of which is thus omitted.

The general construction of the motion detector 100, the robot cleaner 200 and the network connector 300 will now be described in detail. The specific construction of the motion detector 100, the robot cleaner 200 and the network connector 300 can vary according to a designer.

First, the motion detector 100 includes: first and second infrared ray transceivers 101 for detecting certain motion of a trespasser in a trespass area; a controller for generating a motion detect signal when motion of a trespasser is detected by the first and second infrared ray transceivers 101 and 102; and an RF signal generator 104 for generating an RF signal (referred to as an ‘RF motion detect signal’, hereinafter) to inform about trespassing based on the motion detect signal generated by the controller 103.

The motion detector 100 can be installed at a window of the living room, a window of the inner room, a veranda and so on of a house that can be regarded as a dangerous zone as well as at a door in the house. Preferably, the motion detector 100 has such a structure that it can be attached and detached.

The robot cleaner 200 includes an RF signal transceiver 202 for receiving the RF motion detect signal output from the motion detector 100; a microcomputer 203 for generating a control signal to photograph the trespass area region based on the RF motion detect signal output from the RF signal transceiver 202; and a camera 201 for photographing the trespass area according to a control signal of the microcomputer 203 and outputting an image signal of the photographed trespass area to the microcomputer 203.

The microcomputer 203 processes the image signal output from the camera 201 and outputs the processed image signal to the RF signal transceiver 202. The RF signal transceiver 202 converts the image signal output from the microcomputer 203 into an RF image signal and outputs the converted RF image signal to the network connector 300.

The network connector 300 includes an RF signal receiver 301 for receiving the RF motion detect signal and the RF image signal from the RF signal transceiver 202; a CPU 302 for converting the RF motion detect signal and the RF image signal received by the RF signal receiver 301 into a transfer protocol for network connection and transmitting the converted transfer protocol to the mobile terminal of the user through the wireless Internet network; and a storing unit 303 for storing an image signal received by the RF receiver 301.

The operation of the trespass detecting system using a robot cleaner in accordance with the first embodiment of the present invention will now be described in detail with reference to FIG. 3.

First, when a cleaning mode of the robot cleaner 200 is switched to a trespass detection mode, the first and second infrared ray transceiver 101 and 102 of the motion detector 100 check whether there is certain motion of a trespasser in the trespass area. A method for detecting motion can be easily performed by a person skilled in the art, so detailed description of it is omitted. Herein, the first infrared ray transceiver 101 is installed at a position of the motion detector 100 which corresponds to the height of the robot cleaner 200, and the second infrared ray transceiver 102 is installed at a position higher than the position of the first infrared ray transceiver 101.

If certain motion of a trespasser is detected by the second infrared ray transceiver 102 installed at the motion detector 100, or if certain motion of a trespasser is detected simultaneously by the first and second infrared ray transceivers 101 and 102, the controller 103 generates a motion detect signal and outputs the generated motion detect signal to the RF signal generator 104.

The RF signal generator 104 converts the motion detect signal output from the controller 103 into an RF signal and transmits the converted RF signal to the RF signal transceiver 202 of the robot cleaner 200. Herein, the RF signal generator 104 transmits the RF signal to the RF signal transceiver 202 of the robot cleaner 200 through wireless communication, and the RF signal means an RF motion detect signal for informing about trespassing of a trespasser.

Thereafter, the RF signal transceiver 202 of the robot cleaner 200 receives the RF motion detect signal output from the motion detector 100 and outputs the received RF motion detect signal to the microcomputer 203.

The microcomputer 203 generates a control signal for photographing the trespass area based on the RF motion detect signal output from the RF signal transceiver 202, and outputs the generated control signal to the camera 201.

In this respect, when the RF motion detect signal is input from the RF signal transceiver 202, the microcomputer 203 moves the robot cleaner 200 to a pre-set position (e.g., a position where the front door can be photographed) and then outputs a control for photographing the trespass area (e.g., the door) to the camera. The pre-set position can overlap with a cleaning position for cleaning.

The camera 201 photographs the trespass area according to the control signal output from the microcomputer 203 and outputs an image signal of the photographed trespass area to the microcomputer 203.

The microcomputer 203 processes the image signal output from the camera 201 and outputs the processed image signal to the RF signal transceiver 202. At this time, the RF signal transceiver 202 converts the image signal output from the microcomputer 203 into an RF image signal and outputs the converted RF image signal to the RF signal receiver 301 of the network connector 300.

Thereafter, the RF signal receiver 301 of the network connector 300 receives the RF motion detect signal and the RF image signal from the RF signal transceiver 202, and outputs the received RF image signal and RF motion detect signal to the CPU 302. At this time, the storing unit 303 stores the RF image signal received by the RF signal receiver 301.

The CPU 302 converts the RF motion detect signal and the RF image signal received by the RF signal receiver 301 into a transfer protocol for network communication, and transmits the motion detect signal and the image signal converted into the transfer protocol to the mobile terminal of the user through the wireless Internet network. Herein, the network connector 303 is installed at a charging station for providing power to the robot cleaner 200 and receives power supplied from the charging station.

A trespass detecting system in accordance with second and third embodiments of the present invention will be described.

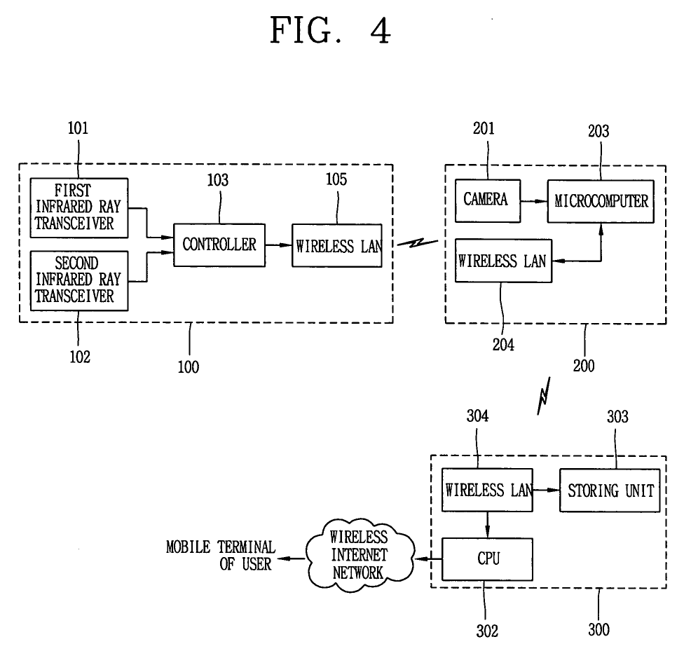

FIG. 4 is a block diagram showing the construction of a trespass detecting system using a robot cleaner in accordance with a second embodiment of the present invention.

As shown in FIG. 4, a trespass detecting system using a robot cleaner in accordance with the second embodiment of the present invention is constructed such that a motion detect signal and an image signal are transmitted through wireless LANs 105, 204 and 304, instead of the RF communicating units 104, 202 and 301. Namely, the construction of the second embodiment is the same as the first embodiment except for the wireless LANs 105, 204 and 304, so description of the similar construction is omitted.

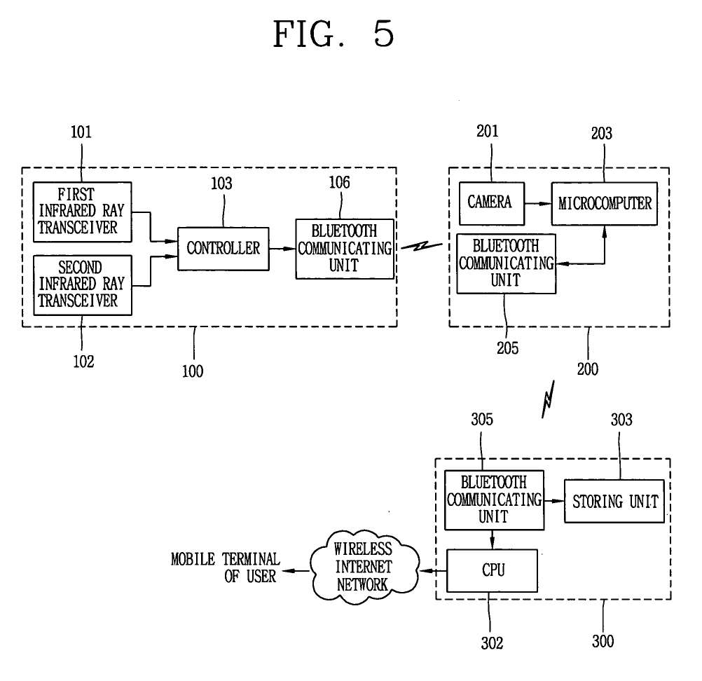

FIG. 5 is a block diagram showing the construction of a trespass detecting system using a robot cleaner in accordance with a third embodiment of the present invention.

As shown in FIG. 5, a trespass detecting system using the robot cleaner in accordance with a third embodiment of the present invention is constructed such that a motion detect signal and an image signal are transmitted through bluetooth communicating units 106, 205 and 305, instead of the RF communicating units 104, 202 and 301. Namely, the construction of the third embodiment is the same as the first embodiment except for the bluetooth communicating units 106, 205 and 305, so description of the construction is omitted.

A trespass detecting method using the robot cleaner in accordance with the present invention will be described with reference to FIGS. 3 to 5 as follows.

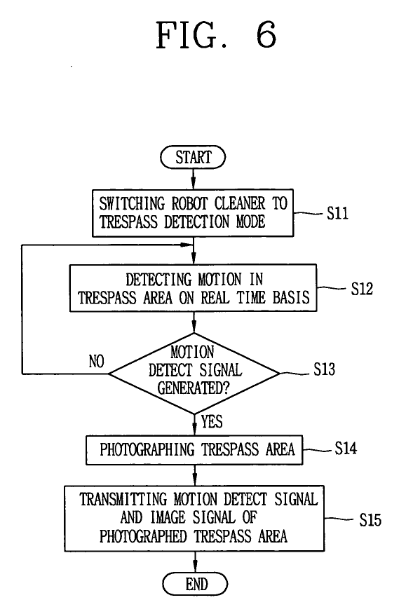

FIG. 6 is a flow chart of a trespass detecting method using the robot cleaner in accordance with an aspect of the present invention.

First, the motion detector 100 is installed at an area considered to be dangerous by a user. At this time, if the user goes out or goes to bed, the mode of the robot cleaner 200 is switched to a trespass detection mode by the user (step S11). Namely, when the robot cleaner 200 is switched to the trespass detection mode, a mode of the motion detector 100 is also activated to the trespass detection mode.

Thereafter, the motion detector 100 checks whether certain motion of a trespasser is detected in the trespass area on a real time basis by using the first and second infrared ray transceivers 101 and 102. For example, if certain motion is detected by the second infrared ray transceiver 102 installed at the motion detector 100 or certain motion is detected by the first and second infrared ray transceivers 101 and 102, the controller 103 determines that there is a trespasser in the trespass area. Detecting of the motion through the infrared ray transceiver can be easily performed by a person skilled in the art, so detailed description of it is omitted.

When the certain motion of the trespasser is detected, the motion detector 100 transmits a motion detect signal to the robot cleaner 200.

The robot cleaner 200 determines whether the motion detect signal is received (step S13), and when the motion detect signal is received, the robot cleaner is moved to the trespass area (e.g., the door of a house), photographs the trespass area through the camera 201 and then outputs an image signal of the photographed trespass area to the network connector 300 (step S14).

The motion detect signal and the image signal can be converted into an RF signal and transmitted through the RF transceivers 104 and 202, can be converted into a wireless communication signal and transmitted through the wireless LANs 105 and 204, or can be converted into the bluetooth communication signal and transmitted through the bluetooth communicating units 106 and 205.

Thereafter, the network connector 300 converts the motion detect signal and the image signal transmitted from the robot cleaner 200 into a transfer protocol for network communication, and then transmits the signals converted into the transfer protocol to a mobile terminal of the user through the wireless Internet network (step S15).

Accordingly, the user can check whether a trespasser has trespassed his/her house through the mobile terminal on a real time basis, or quickly report identification of the trespasser to the police.

In addition, by locking the door of the trespass area through the mobile terminal that can control the door remotely, the trespasser can be isolated in the trespass area.

In other words, the detector for detecting motion is installed at a position where a trespasser can enter, and when a trespasser enters a house, the trespassing of the trespasser is quickly reported to the user by using the motion detect function of the detector and the patrolling function of the robot cleaner.

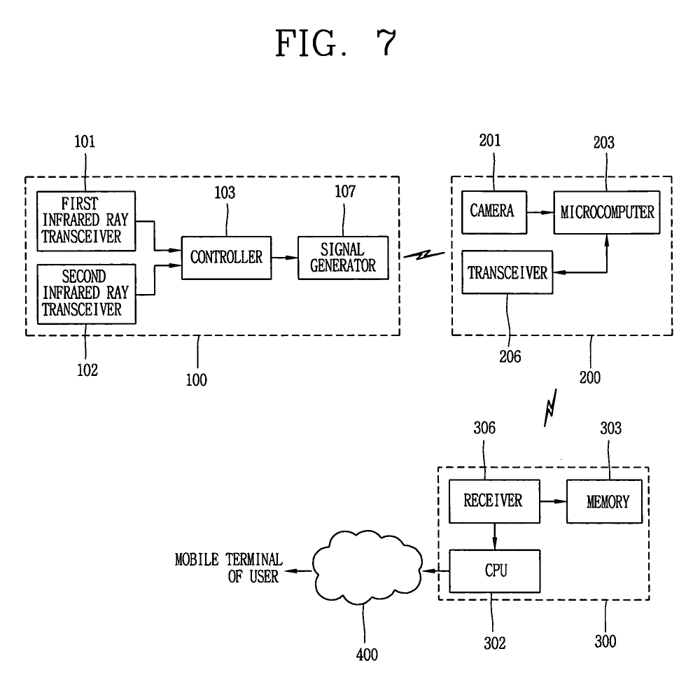

As shown on FIG. 7, a trespass detecting system using a robot cleaner in accordance with another embodiment is constructed such that a motion detect signal and an image signal are transmitted though a signal generator 107, transceiver 206, and receiver 306, instead of RF communicating units 104, 202, 301. Namely, the construction of this embodiment is similar to the first embodiment, except the signal generator can be any type of signal generator, such as an RF signal generator, a bluetooth signal communicating unit, etc. The transceiver 206 and receiver 306 differ from the units described in the first embodiment, in that the transceiver 206 and receiver 306 can be any type of transceiver and receiver, such as an RF signal transceiver/receiver, wireless LAN signal transceiver/receiver, bluetooth signal communicating unit, etc. Description of the elements similar to the elements described in the first embodiment is omitted.

Another difference shown in FIG. 7 is the communication to the mobile terminal of the user. In this embodiment, the communication is not via a wireless Internet network. Rather, network 400, such as a CDMA GSM, UMTS, TDMA, GPRS, EDGE, W-CDMA, or WiMax network, is used instead. In this case, the network connector 300 converts the motion detect signal and/or the image signal into the appropriate protocol, and then transmits the converted signal(s) via the network 400. Although these networks are listed as examples of networks for communicating to the user terminal, the examples are non-limiting and any equivalent or similar networks could also be substituted.

As so far described, the trespass detecting system and method using the mobile robot in accordance with the present invention have the following advantages.

That is, for example, a specific area of a house is monitored on a real time basis, and when a trespasser is detected in the specific area, the specific area is quickly photographed and the photographed image is transmitted to the user. Thus, an enhanced security function can be performed.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A trespass detecting system comprising:
a motion detector installed at a specific area, detecting motion and in response generating a motion detect signal, and transmitting the generated motion detect signal;
a mobile robot for photographing the specific area based on the motion detect signal and transmitting the photographed image signal; and
a network connector for transmitting the motion detect signal and the image signal to a user terminal through a network.

2. The system of claim 1, wherein the mobile robot is a robot cleaner.

3. A trespass detecting system comprising:
a motion detector installed in an area, detecting motion and in response generating a motion detect signal, and transmitting the generated motion detect signal;
a mobile robot for photographing a specific area with a camera, the mobile robot photographing the specific area based on the motion detect signal, and transmitting an image signal of the photographed specific area; and
a network connector for transmitting the motion detect signal and the image signal to a mobile terminal of a user through a wireless network.

4. The system of claim 3, wherein the mobile robot is a robot cleaner.

5. The system of claim 3, wherein the motion detector comprises:
first and second infrared ray transceivers for detecting whether motion of a trespasser is present in the specific area;
a controller for generating the motion detect signal when motion of the trespasser is detected by the first and second infrared ray transceivers; and
a first wireless communicating unit for converting the motion detect signal output from the controller into a wireless communication signal and transmitting the converted wireless communication signal.

6. The system of claim 5, wherein the first infrared ray transceiver is installed at a position of the motion detector that corresponds to a height of the mobile robot and the second infrared ray transceiver is installed at a position higher than the position of the first infrared ray transceiver.

7. The system of claim 6, wherein if motion is detected by the second infrared ray transceiver or motion is detected simultaneously by the first and second infrared ray transceivers, the controller generates the motion detect signal.

8. The system of claim 5, wherein the first wireless communicating unit comprises an RF signal generator for converting the motion detect signal into an RF motion detect signal and transmitting the converted RF motion detect signal.

9. The system of claim 5, wherein the first wireless communicating unit comprises a wireless LAN communicating unit.

10. The system of claim 5, wherein the first wireless communicating unit comprises a bluetooth communicating unit for converting the motion detect signal into a bluetooth communication signal and transmitting the converted bluetooth communication signal.

11. The system of claim 4, wherein the robot cleaner is configured to be switched to a trespass detection mode by a user when the user.

12. The system of claim 3, wherein the mobile robot comprises:
a second wireless communicating unit for receiving the motion detect signal;
a controller that generates a control signal for photographing the specific area based on the motion detect signal; and
a camera for photographing the specific area based on the control signal and outputting an image signal of the photographed specific area,
wherein, the controller outputs the image signal to the second wireless communicating unit, and the second wireless communicating unit converts the image signal into a wireless communication signal and transmits the converted wireless communication signal to the network connector.

13. The system of claim 12, wherein the second wireless communicating unit comprises an RF communicating unit for receiving the motion detect signal transmitted from the motion detector, converting the image signal into an RF image signal, and transmitting the converted RF image signal to the network connector.

14. The system of claim 12, wherein the second wireless communicating unit comprises a wireless LAN communicating unit for receiving the motion detect signal transmitted from the motion detector, converting the image signal into a wireless LAN communication signal and transmitting the converted wireless communication signal.

15. The system of claim 12, wherein the second wireless communicating unit comprises a bluetooth communicating unit for receiving the motion detect signal transmitted from the motion detector, converting the image signal into a bluetooth communication signal and transmitting the converted bluetooth communication signal.

16. The system of claim 4, wherein the network connector is installed at a charging station that provides power to the robot cleaner and receives power from the charging station.

17. The system of claim 3, wherein the network connector comprises:
a third wireless communicating unit for receiving the motion detect signal and the image signal;
a CPU for converting the motion detect signal and the image signal into a transfer protocol for the wireless network, and transmitting the converted signals to the mobile terminal of the user through the wireless network; and
a memory for storing the image signal.

18. The system of claim 17, wherein the third wireless communicating unit comprises an RF communicating unit.

19. The system of claim 17, wherein the wireless communicating unit comprises a wireless LAN communicating unit.

20. The system of claim 17, wherein the wireless communicating unit comprises a bluetooth communicating unit.

21. A trespass detecting system comprising:
a motion detector including infrared ray transceivers for detecting whether motion of a trespasser is present in a specific area, a controller for generating a motion detect signal when motion of the trespasser is detected by at least one of the infrared ray transceivers, and a first wireless communicating unit for converting the motion detect signal output from the controller into a wireless communication signal and transmitting the converted wireless communication signal;
a robot cleaner including a second wireless communicating unit for receiving the motion detect signal, a control mechanism for generating a control signal for photographing the specific area, and a camera for photographing the specific area based on the control signal and outputting an image signal of the photographed specific area; and
a network connecting unit including a third wireless communicating unit for receiving the motion detect signal and the image signal from the second wireless communicating unit, a CPU for converting the motion detect signal and the image signal received through the third wireless communicating unit into a transfer protocol for a wireless network and transmitting the converted image signals to a mobile terminal of a user through the wireless network, and a memory for storing the image signal received through the third wireless communicating unit,
wherein the control mechanism transmits the image signal output from the camera to the second wireless communicating unit and the second wireless communicating unit transmits the image signal output from the microcomputer to the network connecting unit through wireless communication.

22. The trespass detecting system of claim 21, in which the wireless network comprises a CDMA network.

23. The trespass detecting system of claim 21, in which the wireless network comprises a GSM network.

24. A trespass detecting method using a robot cleaner comprising:
switching a mode of the robot cleaner to a trespass detection mode;
detecting motion of a trespasser, who is trespassing in a specific area, through an infrared ray transmitter/receiver and, in response, generating a motion detect signal;
photographing the specific area with a camera of the robot cleaner based on the motion detect signal and outputting an image signal of the photographed specific area; and
transmitting the image signal to a mobile terminal of a user through a wireless network.

25. The method of claim 24, wherein the motion detect signal and the image signal are converted into a transfer protocol of the wireless network.

26. A trespass detecting method for use with a mobile robot, comprising:
detecting motion of a trespasser in an area;
generating a motion detect signal in response to the detecting;
transmitting the motion detect signal to the mobile robot;
photographing the area with a camera of the mobile robot, based upon the motion detect signal;
outputting an image signal based upon the photographing; and
transmitting the image signal and the motion detect signal, via a CDMA network, to a terminal of a user.

27. The method of claim 26, further comprising receiving instructions to switch a mode of the mobile robot to a trespass detection mode.

28. A trespass detecting mobile robot system comprising a mobile robot, the system comprising:
a receiver that receives a motion detect signal generated in response to detection of a trespasser in a monitored area;
a camera that photographs the monitored area in response to receiving the motion detect signal;
a signal generator that generates an image signal based upon the photographing; and
a CDMA transmitter that transmits the image signal to a user terminal via a CDMA network.

29. The mobile robot system of claim 28, in which the CDMA transmitter is within a network connector that receives the image signal from a mobile robot transmitter.

30. The mobile robot system of claim 29, in which the mobile robot transmitter further transmits the motion detect signal to the network connector, and in which the CDMA transmitter further transmits the motion detect signal to the user terminal via the CDMA network.

31. The mobile robot system of claim 28, in which the mobile robot comprises a robot cleaner.

32. A trespass detecting method for use with a mobile robot, comprising:
detecting motion of a trespasser in an area;
generating a motion detect signal in response to the detecting;
transmitting the motion detect signal to the mobile robot;
photographing the area with a camera of the mobile robot, based upon the motion detect signal;
outputting an image signal based upon the photographing; and
transmitting the image signal and the motion detect signal, via a GSM network, to a terminal of a user.

33. The method of claim 32, further comprising receiving instructions to switch a mode of the mobile robot to a trespass detection mode.

34. A trespass detecting mobile robot system comprising a mobile robot, the system comprising:
a receiver that receives a motion detect signal generated in response to detection of a trespasser in a monitored area;
a camera that photographs the monitored area in response to receiving the motion detect signal;
a signal generator that generates an image signal based upon the photographing; and
a GSM transmitter that transmits the image signal to a user terminal via a GSM network.

35. The mobile robot system of claim 34, in which the GSM transmitter is within a network connector that receives the image signal from a mobile robot transmitter.

36. The mobile robot system of claim 35, in which the mobile robot transmitter further transmits the motion detect signal to the network connector, and in which the GSM transmitter further transmits the motion detect signal to the user terminal via the GSM network.

37. The mobile robot system of claim 34, in which the mobile robot comprises a robot cleaner.

38. A trespass detecting method for use with a mobile robot, comprising:
detecting motion of a trespasser in an area;
generating a motion detect signal in response to the detecting;
transmitting the motion detect signal to the mobile robot;
photographing the area with a camera of the mobile robot, based upon the motion detect signal;
outputting an image signal based upon the photographing; and
transmitting the image signal and the motion detect signal, via an wireless network, to a terminal of a user.

39. The method of claim 38, further comprising receiving instructions to switch a mode of the mobile robot to a trespass detection mode.

40. The method of claim 38, in which the wireless network comprises a UMTS network.

41. The method of claim 38, in which the wireless network comprises a TDMA network.

42. The method of claim 38, in which the wireless network comprises a GPRS network.

43. The method of claim 38, in which the wireless network comprises an EDGE network.

44. The method of claim 38, in which the wireless network comprises a W-CDMA network.

45. The method of claim 38, in which the wireless network comprises a WiMax 802.16 network.

46. A trespass detecting mobile robot system comprising a mobile robot, the system comprising:
a receiver that receives a motion detect signal generated in response to detection of a trespasser in a monitored area;
a camera that photographs the monitored area in response to receiving the motion detect signal;
a signal generator that generates an image signal based upon the photographing; and
a wireless transmitter that transmits the image signal to a user terminal via a wireless network.

47. The mobile robot system of claim 46, in which the wireless transmitter is within a network connector that receives the image signal from a mobile robot transmitter.

48. The mobile robot system of claim 47, in which the mobile robot transmitter further transmits the motion detect signal to the network connector, and in which the wireless transmitter further transmits the motion detect signal to the user terminal via the wireless network.

49. The mobile robot system of claim 46, in which the mobile robot comprises a robot cleaner.

50. The mobile robot system of claim 46, in which the wireless network comprises a UMTS network.

51. The mobile robot system of claim 46, in which the wireless network comprises a TDMA network.

52. The mobile robot system of claim 46, in which the wireless network comprises a GPRS network.

53. The mobile robot system of claim 46, in which the wireless network comprises an EDGE network.

54. The mobile robot system of claim 46, in which the wireless network comprises a W-CDMA network.

55. The mobile robot system of claim 46, in which the wireless network comprises a WiMax 802.16 network.

56. The mobile robot system of claim 46, in which the wireless network comprises a CDMA2000 network.
